(19) United States
(12) Patent Application Publication
(10) Pub. No.: US 2024/0428621 A1
(43) Pub. Date: Dec. 26, 2024

(54) SYSTEMS AND METHODS FOR MEASUREMENT AND ANALYSIS OF HUMAN BIOMECHANICS WITH SINGLE CAMERA VIEWPOINT

(71) Applicant: AiKynetix, LLC (TX), Houston, TX (US)

(72) Inventors: Denis Akhiyarov, Los Gatos, CA (US); Anton Galvas, Houston, TX (US); Radmir Sultamuratov, Houston, TX (US); Yuan Zi, Houston, TX (US)

(73) Assignee: AiKynetix, LLC (TX), Houston, TX (US)

(21) Appl. No.: 18/818,141

(22) Filed: Aug. 28, 2024

Related U.S. Application Data
(63) Continuation of application No. PCT/US23/69472, filed on Jun. 30, 2023.
(60) Provisional application No. 63/367,455, filed on Jun. 30, 2022.

(51) Int. Cl. G06V 40/20

(52) U.S. Cl. CPC G06V 40/25

(57) ABSTRACT

A method (400) for measuring and analyzing human biomechanics performed by a mobile device (402). The method includes performing a human motion capture process (412) of a human runner and producing high-speed video (414) from the human motion capture process. The method includes performing a frame filtering process (422) on the high-speed video to produce individual frames showing discrete positions of the captured human motion and performing a human pose segmentation process (424) based on the individual frames. The method includes building a biomechanics model (426) of the human runner.

### CROSS-REFERENCE TO RELATED APPLICATIONS

This application claims the benefit of the filing date of U.S. Provisional Patent Application 63/367,455, filed Jun. 30, 2022, which is hereby incorporated by reference.

### FIELD

This application relates to the measurement and analysis of human biomechanics using machine learning technology. In particular, this application relates to a system that evaluates the performance and biomechanics of individuals engaged in various sports and physical activities, as well as in physical rehabilitation and injury prevention. The system can capture data with a single video camera viewpoint and interprets the data using computer vision and biomechanics models to provide valuable insights and assessments.

### BACKGROUND

Advances in sports technology have drawn interest for analyzing running performance from data collected using wearables and fitness applications. Tracking the biomechanics of human motion can help improve a runner's form and overall performance. This is helpful for both casual runners and top athletes to prevent injury, improve performance, and even aid medical rehabilitation after an injury. Improper technique can lead to excessive fatigue, an increased likelihood of injuries, suboptimal training, and unrealized potential for an athlete or casual runner.

Current technologies for the measurement of human biomechanics typically require multiple camera viewpoints, markers, and sensors for motion capture. These technologies are limited to use within a laboratory. Laboratory-based motion data is expensive and inaccessible to the masses. Previous attempts to measure and analyze human biomechanics outside of a laboratory and simplify the process have involved the use of accelerometers and the measurement of pace, heart rate, and perceived effort. This technology cannot accurately account for differences in running environment and form and can lead to inaccurate measurements, which will in turn fail to correct a subject's running technique.

Currently technologies also tend to use running power as the primary metric for measuring running intensity and optimizing performance. This measure of running power is correlated with metabolic power, but the underlying assumptions are constrained to laboratory-based environments where data is collected on flat surfaces using specialized equipment. Furthermore, current technology is based on accelerometer data, barometer data, and GPS technology that fails to accurately account for differences in running environments, whole-body mechanics, and footwear conditions. They are typically only available for outdoor performance tracking and have to be approximated for a treadmill. This limits the usefulness of this technology for analyzing human running performance and makes obtaining accurate measurements and feedback inaccessible to the masses.

Other technology designed to measure human biomechanics and metrics, such as wearables, often provide inaccurate readings, either overestimating or underestimating the steps taken and the effort being exerted by an individual. For example, the speed of leg motion is estimated based on the frequency of the hand motion where a wearable is located.

Therefore, a need exists for an intelligent solution for enhancing human motion in sports that can accurately track long-term performance with advanced metrics that are accessible to a wide range of users outside of a laboratory environment.

### SUMMARY

Systems and methods to measure and analyze human biomechanics are described herein. Embodiments generally include collecting biometric data from a user, capturing video images of a user in motion with a mobile device, processing the biometric data and the video images in a computer vision model and a biomechanics model to generate a computed dataset, wherein the computer vision model and the biomechanics model self-calibrate. Disclosed embodiments can include processing the biometric data and the video images in a computer vision model and a biomechanics model to generate a computed dataset and interpreting the data using advanced computer vision and biomechanics models. Disclosed embodiments can assess and improve performance, prevent injuries, aid in rehabilitation, and support multisport applications.

One or more embodiments include the method of the preceding paragraph wherein the computer vision model and the biomechanics model communicate within a processing unit of the mobile device.

One or more embodiments include the method of any preceding paragraph, further comprising generating an advisory recommendation for the user by processing the computed dataset and the biometric data with at least one selected condition precedent. These recommendations can assist in injury prevention strategies, rehabilitation protocols, performance optimization techniques, and multisport training.

Further embodiments include a system for measuring and analyzing human biomechanics that generally include a computer vision model, the computer vision model capable of extracting selected datapoints from collected data, a biomechanics model communicably connected to the computer vision model, the biomechanics model capable of interpreting the selected datapoints to calculate a plurality of desired variables, and an edge device capable of processing the collected data and transferring the desired variables to an end-user display.

One or more embodiments include the system of any preceding paragraph wherein the computer vision model and the biomechanics model self-calibrate.

One or more embodiments include the system of any preceding paragraph wherein the collected data comprises video frames captured by the edge device and biometric data input submitted by a user. This data can be used by the systems and processes disclosed herein to enable a holistic assessment of performance and biomechanics in various contexts, including injury prevention and rehabilitation scenarios.

One or more embodiments include the system of any preceding paragraph wherein the system is capable of deep learning.

One or more embodiments include the system of any preceding paragraph further comprising an advisory model capable of processing the desired variables and collected data to generate an advisory recommendation for a user. This feature supports personalized training plans, injury prevention strategies, rehabilitation protocols, and multisport applications tailored to individual needs and requirements.

Another embodiment includes a method for measuring and analyzing human biomechanics performed by a mobile device. The method includes performing a human motion capture process of a human runner by the mobile device. The method includes producing high-speed video from the human motion capture process by the mobile device. The method includes performing a frame filtering process on the high-speed video, by the mobile device, to produce individual frames showing discrete positions of the captured human motion. The method includes performing a human pose segmentation process based on the individual frames, by the mobile device. The method includes building a biomechanics model of the human runner by the mobile device. The method includes producing running metrics from the biomechanics model by the mobile device. In various embodiments, the method can include building biomechanics models to provide valuable insights and metrics for performance assessment, injury prevention, rehabilitation, and multisport training.

Various embodiments include a mobile device having a processor and camera system and configured to perform processes disclosed herein.

In one or more embodiments, performing a human motion capture process and producing high-speed video is performed by a camera system of the mobile device.

One or more embodiments include refining the biomechanics model of the human runner based on subsequent individual frames of the high-speed video.

In one or more embodiments, the human pose segmentation process is also based on force plate measurements. In one or more embodiments, the biomechanics model is also based on inertial measurements. In one or more embodiments, the human pose segmentation process is also based on inertial measurements. In one or more embodiments, the biomechanics model is also based on force plate measurements.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a high-level schematic overview of the flow of data within the present disclosure.

FIG. 2 illustrates certain advanced metrics the present disclosure may track.

FIG. 3 illustrates a high-level overviews of certain embodiments of the present disclosure.

FIG. 4 illustrates a process in accordance with disclosed embodiments.

FIG. 5 illustrates various depictions of a potential end-user displays of the present disclosure.

FIGS. 6 and 7 illustrate examples of logical structures of a model in accordance with disclosed embodiments.

FIG. 8 illustrates a submodel in accordance with disclosed embodiments.

FIG. 9 illustrates a corrected kinematic block generalized for angles, in accordance with disclosed embodiments.

FIG. 10 illustrates a block Fₙ(t) Fourier series equation in accordance with disclosed embodiments.

FIG. 11 illustrates a submodel for the equation of motion along the O_{y} axis in accordance with disclosed embodiments.

FIG. 12 illustrates block F_{τ}(t) in accordance with disclosed embodiments.

FIG. 13 illustrates a submodel for the equation of motion along the Ox-axis in accordance with disclosed embodiments.

FIG. 14 illustrates a submodel for the block Δx_{c} in accordance with disclosed embodiments.

FIG. 15 illustrates a submodel for the block Δy_{c} in accordance with disclosed embodiments.

FIG. 16 illustrates a submodel for determining the change in potential energy ΔW_{P} in accordance with disclosed embodiments.

FIG. 17 illustrates a submodel for the calculation of the change in kinetic energy ΔW_{K}.

FIG. 18 illustrates a submodel for the calculation of the work of the support reaction force.

FIGS. 19 and 20 illustrate the Fourier model added to the calculation of the support reaction force, in accordance with disclosed embodiments.

### DETAILED DESCRIPTION

The figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Any ranges include iterative ranges of like magnitude falling within the expressly stated ranges or limitations.

The present disclosure relates to a system and method that measures video analytics for full-body human motion analysis. The disclosure utilizes various real-time tracking, modeling, and quantifying tools. Herein, the term “run,” or variations thereof, may be used. However, it should be understood by those of ordinary skill in the art that the present disclosure is not restricted to measuring running performance. It can be expanded to other human motion analysis applications such as walking, jumping, dancing, or other various athletic competitions and sports.

Analyzing performance in various sports and physical activities, including running, can be achieved by leveraging data collected from wearables and fitness applications. Tracking the biomechanics of human motion can contribute to enhancing an individual's form, performance, and overall results. This technology proves beneficial for a wide range of individuals, including casual participants and elite athletes, as it aids in injury prevention, performance enhancement, and supports medical rehabilitation post-injury. The accurate assessment of technique and form is crucial as improper execution can lead to excessive fatigue, increased injury risks, suboptimal training outcomes, and unrealized potential for athletes and participants in any sport or physical activity.

With the present disclosure, the running performance of an individual can be evaluated by integrating machine learning (ML) computer vision (CV) and a physics-based biomechanics (BM) model implemented on a mobile device, and mechanical power can be measured directly by capturing full-body biomechanics with the mobile device. The present disclosure seeks to eliminate the barriers individuals face when seeking to measure and analyze their own human biomechanics, including the need for expensive and specialized equipment confined to a laboratory environment and not available to the general public.

The present disclosure can utilize a camera integrated into a mobile device for real-time video frame filtering and streaming. These video frames are analyzed by the CV model, which can extract critical body positions from the images. The BM utilizes both user-inputted data and critical body positions from video images to calculate desired variables, including but not limited to speed, contact time, flight time, elastic recovery, inclination, ground reaction forces, energy distribution, running gait, and running mechanical power by utilizing numerical methods. Human pose estimation is transformed from projected 2D video images to real-world 3D human body position to provide kinematically valid inputs to the BM model. The BM model requires an accurate detection of ground contact time duration and generalization for various running forms and conditions. Further, the trajectory of critical body positions is measured for one stride of running, rather than the more traditional frame-by-frame analysis. This trajectory approach honors the geometric and physics-based constraints of human body parts and can be extended to other types of human motion. These constraints can be incorporated either as a penalty term on the error minimization routine or into the structure of an edge device's neural network. The BM and CV models also receive information regarding ground contact time duration and generalization for various running forms and conditions.

A mobile device as described herein, also referenced as an edge device, refers to any programmable computing device including a mobile phone, tablet computer, laptop computer, special-purpose mobile device, a general-purpose mobile device, and others. A mobile device can include hardware known to those of skill in the art, such as processors, controllers, input-output devices, memory, a camera, a display, data storage, wired or wireless communications circuits, and others, and can be connected to communicate with peripheral hardware, such as an external camera, printer, or other devices. Such a mobile device may be referred to simply as “the system” herein.

The present disclosure incorporates a hybrid physics and ML approach that is not limited to critical body position predictions as compared to existing CV models of human pose estimation. Rather, a biomechanical modeling approach is utilized to predict forces and running power.

To increase accuracy, reduce power consumption, and reduce latency within the edge device, the BM and CV models discount inefficient and statistically insignificant processes. This allows the computation of real-time inference by analyzing only the remaining, statistically significant strides. Further, consecutive frames are collected in one batch. This allows the data to saturate the computational resources more efficiently by parallelizing the computational workload of input frames passing through a neural network.

To solve for real-world use cases of new users utilizing the present disclosure, the model must be fine-tuned outside of the initial laboratory calibrations. This is solved by use transfer learning and self-calibration between the BM and CV models.

The main output of running metrics is the measurement of mechanical running power. Other metrics include speed, distance, cadence, elevation changes, flight time, contact time, balance (right/left), and ground reaction forces. The inputs include body mass, height, age, gender, and body type.

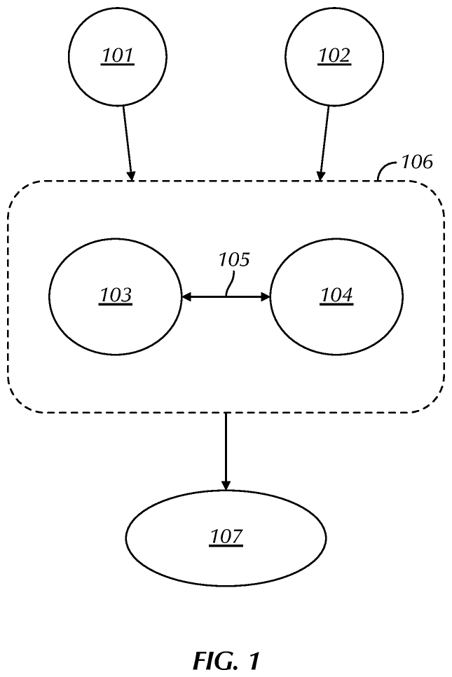

FIG. 1 illustrates a high-level schematic overview of the flow of data within the present disclosure. User-inputted data 101 and video images 102 are transferred to an edge device 106 for processing. This processing can happen within the neural network of a mobile device. The mobile device may be Central Processing Unit (CPU), Graphics Processing Unit (GPU), or Neural Processing Unit (NPU) enabled. The CV model 103 can extract critical body positions from collected data. The BM model 104 can interpret and compute selected datapoints to calculate desired variables, such as running performance and mechanical power. The CV model 103 and BM model 104 are communicably connected 105 to self-calibrate. After data is processed, it is ported to an end-user display 107.

In certain embodiments, an advisory model can further process the computed data and analyze it with user-specific variables to give an individual user recommendations for improving metrics based on their past performance and goals. The recommendation system advises athletes and coaches on how to improve individual running performance.

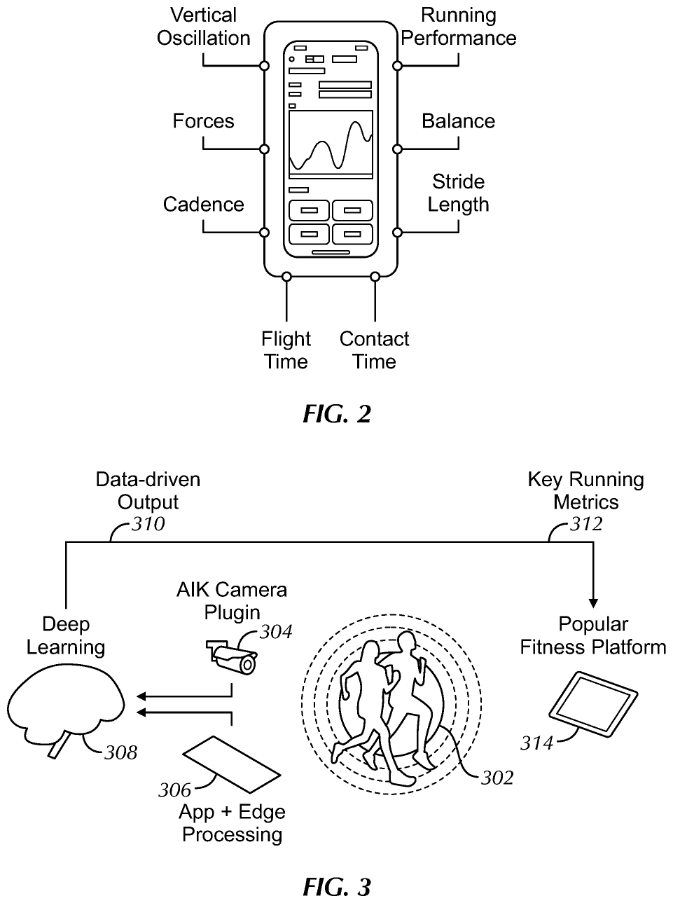

FIG. 2 illustrates certain advanced metrics the present disclosure may track: vertical oscillation, forces, cadence, flight time, contact time, stride length, balance, and running performance.

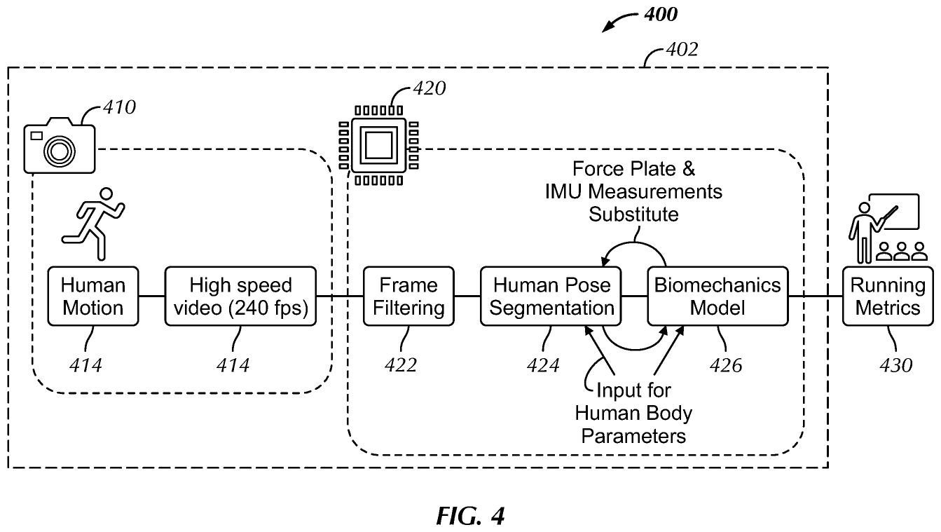

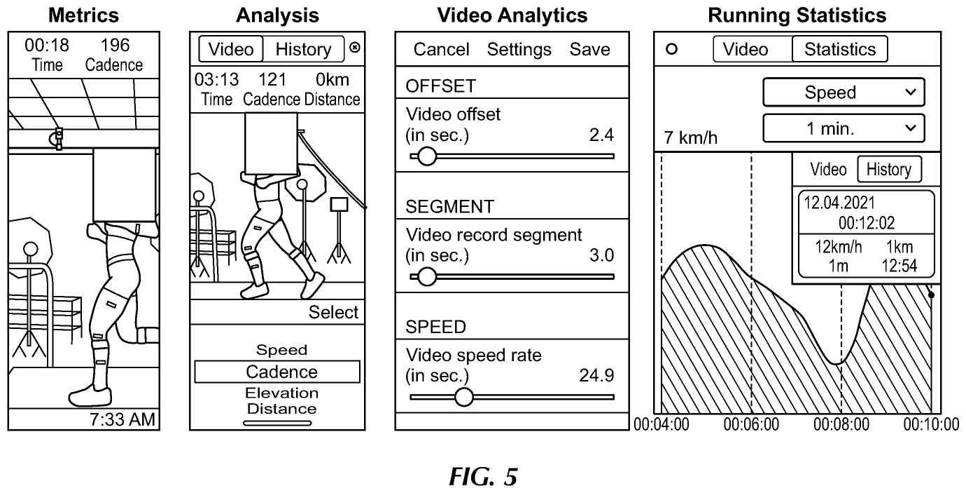

FIGS. 3 and 4 illustrate high-level overviews of certain embodiments of the present disclosure.

FIG. 3 illustrates that images of runners 302 can be captured, while running, by an acquisition integration kit (AIK) camera plugin 304 on an edge device 306 that supports edge processing on a run-analysis application (app). Edge device 306, using the app, produces biomechanical data based on the images.

The app on edge device 306 performs deep learning processes 308 based on the biomechanical data, to produce data-driven output 310 including key running metrics 312.

The running metric 312 can be delivered to a fitness platform 314 on another device to train and guide runners to improve their performance.

FIG. 4 illustrates a process 400 for measuring and analyzing human biomechanics in accordance with disclosed embodiments that can be performed, for example, by an edge device 402 such as a mobile phone, tablet, laptop, or similar device. Aspects of process 400 can be implemented using the models and submodels described in more detail below.

In process 400, at 412, a camera system 410 of edge device 402 can perform a human motion capture process of a human runner.

At 414, the camera system 410 of edge device 402 can produce high-speed video from the human motion capture process 412. High-speed, in some cases, can be 240 frames per second.

At 422, a processor 420 of edge device 402 can perform a frame filtering process on the high-speed video to produce individual frames showing discrete positions of the captured human motion.

At 424, the processor 420 can perform a human pose segmentation process based on the individual frames.

At 426, the processor 420 can build or refine a biomechanics model of the human runner and produce running metrics 430 from the biomechanics model.

Steps 424 and 426 can also be performed based on human body parameters input by a user or automatically determined by the edge device 402.

Those of skill in the art will recognize that the process 400 can be an ongoing process as new video is captured of the human runner and processed as described. In particular, as new high-speed video is produced, filtered, and processed, steps 424 and 426 can be repeated so that the biomechanics model is constantly refined, and that model is used to perform more accurate human pose segmentation.

Further, in addition to the video processing, steps 424 and 426 can also be performed based on force plate measurements that reflect the downward force of the runner on a treadmill or other device. Further, in addition to the video processing, steps 424 and 426 can also be performed based on inertial measurements from an inertial measurement unit (IMU) that detect the motion and change-of-motion in one or more directions by the runner on a treadmill or other device. This additional data can be used to refine the human pose segmentation and/or the biomechanics model, and can help produce more accurate running metrics 430.

FIG. 5 illustrates various depictions of a potential end-user displays of the present disclosure.

Some embodiments have particular advantages in human motion analysis on treadmills. A system as disclosed, using mobile device for motion analytics, is simple, affordable, and available to every athlete in the form of a mobile running lab. Disclosed systems open access to advanced running form analysis and running performance tracking in real-time which is currently not available to the running community.

Processes disclosed herein include human pose estimation based on conversion from 2D video frame to real 3D human body position and motion. This is achieved by calibration of camera projection parameters specific to cameras on mobile devices.

Disclosed embodiments include a hybrid Physics and Machine Learning (ML) approach that is not limited to keypoints (critical body positions) predictions when compared to existing computer vision (CV) models. Disclosed embodiments use biomechanical modeling processes to predict forces and running power, not available today in computer vision models.

Disclosed embodiments can be based on creating, training, updating, and using biomechanics models. The following describes various disclosed techniques that can be used to implement various embodiments.

Structurally, the BM model can be implemented as two large “submodels”: the first one calculates the key running parameters (ω and λ), the value of the vertical component of the support reaction force, and ultimately the trajectory of the center of mass.

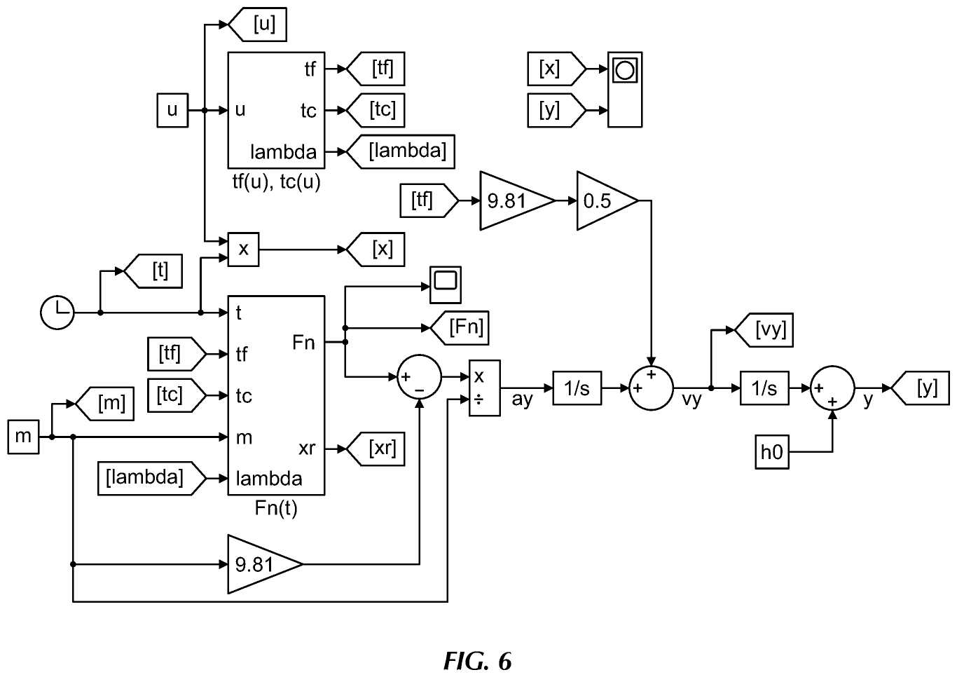

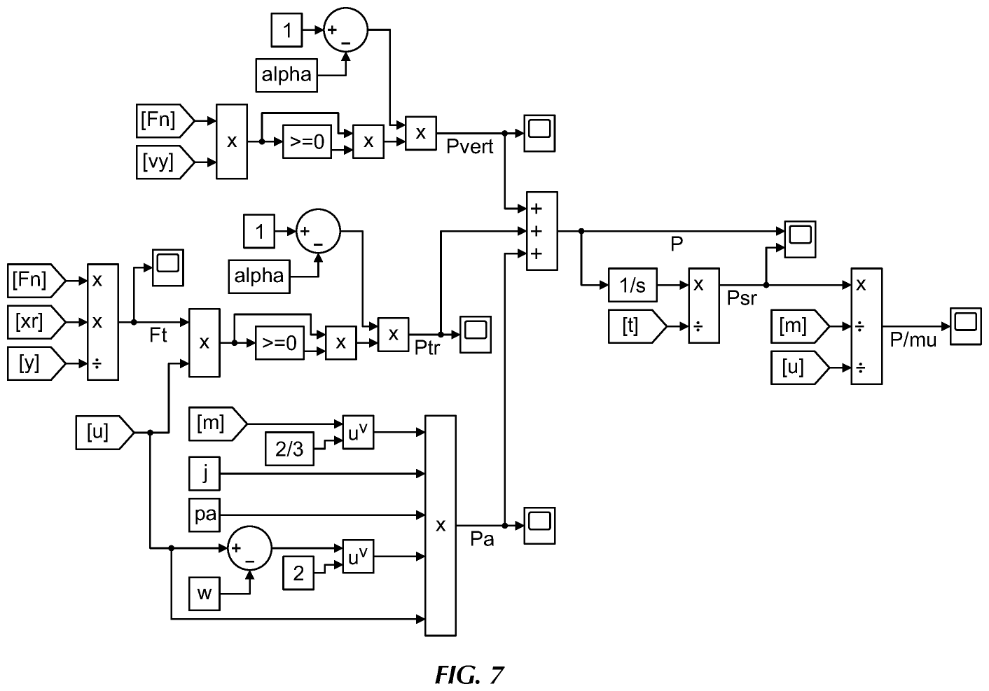

FIGS. 6 and 7 illustrate examples of logical structures of such a model in accordance with disclosed embodiments.

FIG. 6 illustrates an example of a sub-model calculating the center of mass (CM or COM) trajectory. The input data for this submodel are u (the horizontal velocity of the runner's COM), m (its mass), and h₀ (the height of the CM). The output is the relationship y(x).

FIG. 7 illustrates an example of a submodel calculating the biomechanical running power. This second submodel calculates the instantaneous values of the power components expended by the runner. The input data for this submodel, in addition to the input and output data of the first submodel, are α (energy recovery factor), γ (proportionality factor for the calculation of the power compensating the aerodynamic drag), ρa (air density), and w (wind speed). Its outputs are Pvert (the power that compensates for vertical vibrations), Ptr (power to compensate for the work of the horizontal component of the support reaction force), Pa (power consumed for aerodynamic drag compensation), Psr (the average power output of the runner), and P/mu (its specific average power output).

The principles of the first submodel are described in more detail below. The system can first determine the main parameters of the run-frequency (ω) and strut distance (λ), flight time (t_{f}) and strut time (t_{c}).

A submodel for contact and flight times t_{f}(u), t_{c}(u) can be based on equations:

$${t}_{f} = \frac{1}{ω} - \frac{λ}{u} , \qquad ( 1 )$$

$${t}_{c} = \frac{λ}{u ,} \qquad ( 2 )$$

At the initial stage of the calculations, until actual data from the runner is available, ω and λ are calculated using equations derived from

$$ω ( u ) = 0.971 {c}^{- 1} + 0.8 {M}^{- 1} \cdot u - 0.048 {M}^{- 2} c \cdot {u}^{2} and \qquad ( 3 )$$

$$λ ( u ) = 0.284 c \cdot u - 0.0187 {M}^{- 1} {c}^{2} \cdot {u}^{2} , \qquad ( 4 )$$

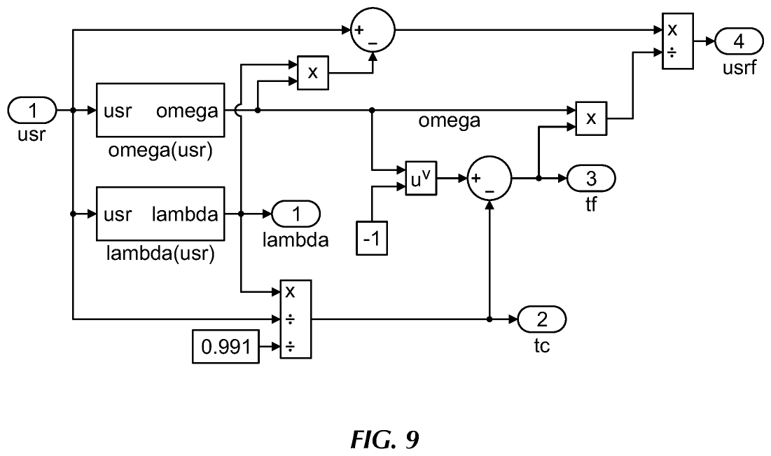

These equations are embedded in the blocks ω(u) and λ(u) (see FIG. 9). Later, these equations can be replaced by input from the system or from the computer vision model.

Having the basic running parameters, the system can start calculating the dependence of the vertical component of the support reaction force on time Fₙ(t), which is performed in the corresponding submodel Fₙ(t).

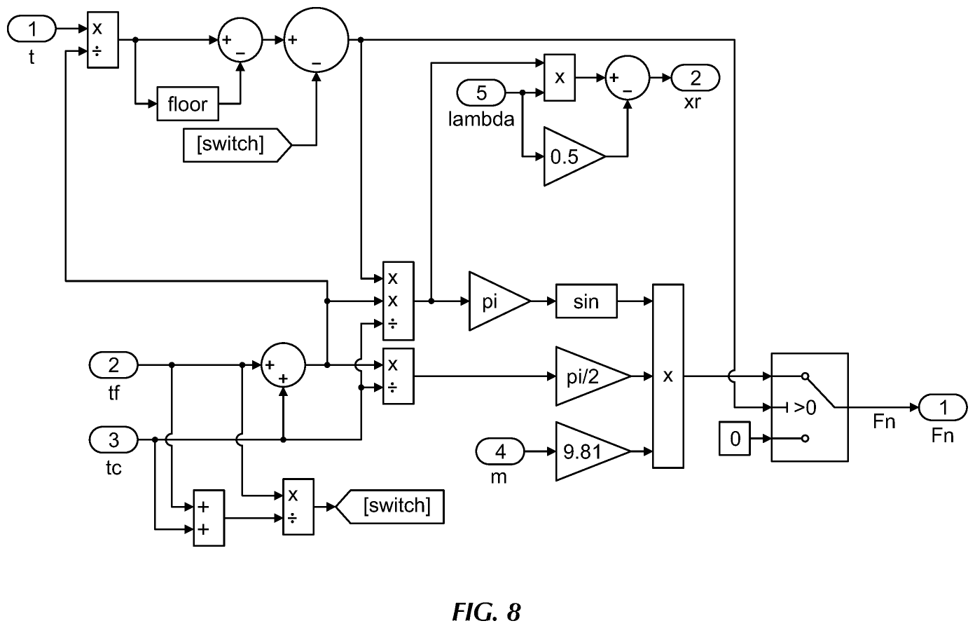

FIG. 8 illustrates submodel for contact ground reaction force (normal component) Fn(t) in accordance with disclosed embodiments. The input parameters for this submodel are t (current time), tf and tc (flight and strut times, m (mass of the runner), and λ (strut length). The output data are Fn (the vertical component of the support reaction force) and xr (projection of position of the CM on the horizontal axis in relation to the point on which the equilibrium force of reaction of the support acts). This parameter can also be used in the second submodel for calculation of the horizontal component of the support reaction force.

The submodel is based on the following equation:

$${F}_{n} ( t ) = \{ \begin{matrix}0 if t ∈ [ 0 , {t}_{f} ] \\ \frac{π m g}{2} \cdot \frac{{t}_{f} + {t}_{c}}{{t}_{c}} \cdot sin ( \frac{π}{{t}_{c}} ( t - {t}_{f} ) ) for t ∈ [ {t}_{f} , {t}_{f} + {t}_{c} ]\end{matrix} \qquad ( 5 )$$

Therefore, the equation was transformed as follows:

$${F}_{n} ( t ) = \qquad ( 6 )$$

$$\{ \begin{matrix}0 if \{ \frac{t}{{t}_{f} + {t}_{c}} \} ∈ [ 0 , \frac{{t}_{f}}{{t}_{f} + {t}_{c}} ] \\ \begin{matrix}\frac{π m g}{2} \cdot \frac{{t}_{f} + {t}_{c}}{{t}_{c}} \cdot sin ( \frac{{t}_{f} + {t}_{c}}{{t}_{c}} \cdot π ( \{ \frac{t}{{t}_{f} + {t}_{c}} \} - \frac{{t}_{f}}{{t}_{f} + {t}_{c}} ) ) if \{ \frac{t}{{t}_{f} + {t}_{c}} \} ∈ \\ [ \frac{{t}_{f}}{{t}_{f} + {t}_{c}} , 1 ]\end{matrix}\end{matrix} ,$$

where

$$\{ \frac{t}{{t}_{f} + {t}_{c}} \}$$

is fractional part from division

$$\frac{t}{{t}_{f} + {t}_{c}} .$$

According to the submodel, it is located as:

$$\{ \frac{t}{{t}_{f} + {t}_{c}} \} = \frac{t}{{t}_{f} + {t}_{c}} - [ \frac{t}{{t}_{f} + {t}_{c}} ] , \qquad ( 7 )$$

where

$$[ \frac{t}{{t}_{f} + {t}_{c}} ]$$

is integer partition

$$\frac{t}{{t}_{f} + {t}_{c}} .$$

A variable has been used for convenience

$$switch = \frac{{t}_{f}}{{t}_{f} + {t}_{c}} ,$$

comparison

$$\{ \frac{t}{{t}_{f} + {t}_{c}} \}$$

with which allows the system to determine whether the runner is in the flight or fall phase. Thus, Fₙ(t) is correctly determined at each step of the runner.

This submodel also defines the dependence xᵣ(t)—the projection of the CM position on the horizontal axis with respect to the point on which the equilibrium force of the support reaction acts. This parameter is important in determining F_{τ}(t), the horizontal component of the support reaction. This can be defined as:

$${x}_{r} = ( t - {t}_{f} ) u - \frac{λ}{2} ; \qquad ( 8 )$$

However, this equation only works correctly for the first running period. Therefore, the equation can be transformed by the system as follows:

$${x}_{r} = \frac{{t}_{f} + {t}_{c}}{{t}_{c}} \cdot ( \{ \frac{t}{{t}_{f} + {t}_{c}} \} - \frac{{t}_{f}}{{t}_{f} + {t}_{c}} ) λ - \frac{λ}{2} ; \qquad ( 9 )$$

In this form, xr is defined correctly at each stage of the process.

Knowing the dependence Fₙ(t), the equation of motion of the runner can be represented as:

$${a}_{y} = \frac{{F}_{n} ( t ) - m g}{m} ; \qquad ( 10 )$$

By integrating this equation twice as shown in FIG. 6, and taking into account the initial conditions

$${v}_{0 y} = g \frac{{t}_{f}}{2} , {y}_{0} = {h}_{0} ,$$

the dependence y(t) is determined. Given that the projection of velocity onto the Ox axis is assumed constant and equal to u, x(t)=ut can be determined. Based on x(t) and y(t), the system determines the trajectory of the CM.

The following describes the second submodel as illustrated in FIG. 7. It calculates the instantaneous values of capacities which compensate the action of various external forces. There are three types of powers: P_{wert} is the power of vertical component of support reaction force, Pₜᵣ is the power of horizontal component of support reaction force, Pₐ is the power of aerodynamic forces.

Pᵥₑᵣₜ is the power of the vertical component of the support reaction force: During a stance, the center of mass first moves downwards and then upwards. When the CM moves downwards, the person does not exert any effort; on the contrary, part of the energy is recovered due to the elasticity of the person's muscles and his shoes. Therefore, the system assumes that at this point the instantaneous value of Pᵥₑᵣₜ=0. In order to lift the CM and the subsequent detachment of the sole from the ground surface, the person is forced to expend its internal energy. In this case power of vertical component of support reaction will be:

$${P}_{F n ( t )} = {F}_{n} ( t ) \cdot {v}_{y} \qquad ( 11 )$$

During the downward movement of the CM, a part of the energy is recovered, equal to

$${W}_{p} = α {\int }_{{t}_{f}}^{{t}_{f} + {t}_{c}} {F}_{n} ( t ) \cdot {v}_{y} dt , \qquad ( 12 )$$

This energy facilitates the human effort already in the upward movement of the CM. The submodel can assume that this energy is released in proportion to the power expended by the person.

Then the power of the released recuperated energy will be equal to:

$${P}_{p} = α {F}_{n} ( t ) \cdot {v}_{y} , \qquad ( 13 )$$

Then the instantaneous power expended by a person to compensate for vertical oscillations during the lifting phase of the CM will be equal:

$${P}_{v e r t} = ( 1 - α ) {F}_{n} ( t ) \cdot {v}_{y} . \qquad ( 14 )$$

At any point in time, Pᵥₑᵣₜ will be defined as:

$${P}_{v e r t} = \{ \begin{matrix}0 , if {F}_{n} ( t ) \cdot {v}_{y} \leq 0 , \\ ( 1 - α ) {F}_{n} ( t ) \cdot {v}_{y} , if {F}_{n} ( t ) \cdot {v}_{y} > 0 .\end{matrix} \qquad ( 15 )$$

This equation forms the basis for the calculation of Pᵥₑᵣₜ in the submodel of FIG. 7.

Pₜᵣ is the power of horizontal component of support reaction force. The system can determine the horizontal component of the support reaction force according to the equation:

$${F}_{τ} ( t ) = \frac{{x}_{r}}{y} {F}_{n} ( t ) \qquad ( 16 )$$

In various embodiments, xᵣ is defined in the submodel Fₙ(t), y is the result of double integration of the equation of motion. The expression (16) itself is derived from the assumption that the support reaction force at any time is directed towards the centre of mass and does not create a torque.

Knowing F_{τ}(t) and the speed of the runner, using the same reasoning as in equations (11)-(15), an expression for the power to compensate for the horizontal component of the support reaction can be determined as:

$${P}_{t r} = \{ \begin{matrix}0 , if {F}_{τ} ( t ) \cdot u \leq 0 , \\ ( 1 - α ) {F}_{τ} ( t ) \cdot u , if {F}_{τ} ( t ) \cdot u > 0.\end{matrix} \qquad ( 17 )$$

Pₐ is the power of aerodynamic forces. Pa can be determined using

$${P}_{a} = γ {m}^{2 / 3} {{ρ}_{a} ( u - w )}^{2} u . \qquad ( 18 )$$

being modelled in the submodel of FIG. 7. Since it was initially assumed that the speed of the athlete during running is constant, the power to compensate for the aerodynamic forces is also constant.

The instantaneous value of the total power is defined as:

$$P = {P}_{v e r t} + {P}_{t r} + {P}_{a} . \qquad ( 19 )$$

The average value of the power consumption at a certain time t, is found as:

$${P}_{s r} = \frac{{\int }_{0}^{t} P d t}{t} . \qquad ( 20 )$$

The required mechanical work per meter of travel per 1 kg is defined as:

$${A}_{mech . yA} = \frac{{P}_{sr}}{m u} . \qquad ( 21 )$$

The system can calculate capacities taking into account changes in treadway inclination angle. In a flat treadway, the projection of the velocity of the CM on the horizontal axis (u) is constant. However, this is not the case in an inclined surface. The equation of motion of the CM in projection to the horizontal axis can be represented as:

$$m \ddot{x} = {F}_{τ} ( t ) \qquad ( 22 )$$

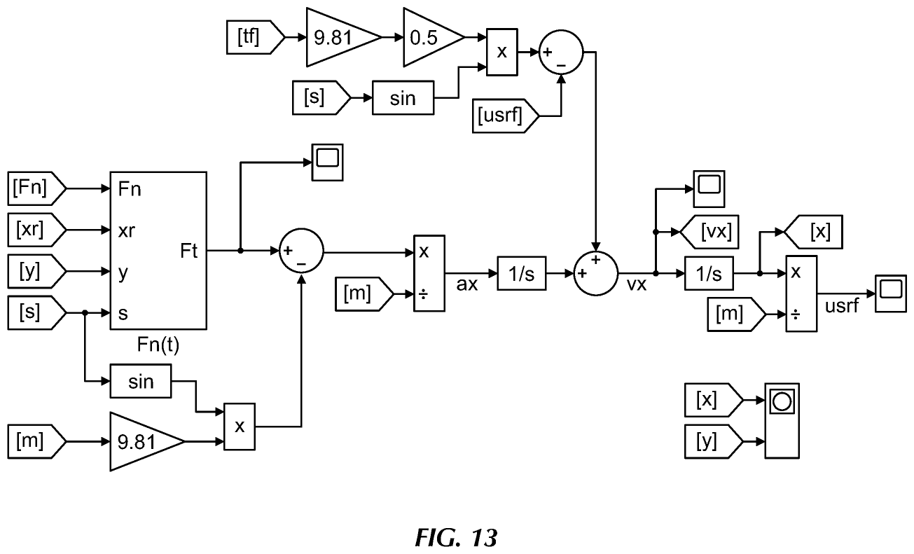

In a flat treadway, gravity acts strictly perpendicular to the running plane, but in real life it is often necessary to run on inclined planes. Therefore, the input variable φ represents the angle of inclination of the surface. When φ>0, running occurs “uphill”, when φ<0, running occurs downhill. FIG. 13 illustrates the location of the axes and forces acting on the person during running.

The simulation of the motion of the CM can be determined based on two equations:

$$m \ddot{x} = {F}_{τ} ( t ) - mg sin φ , \qquad ( 23 )$$

$$m \ddot{y} = {F}_{n} ( t ) - mg cos φ ; \qquad ( 24 )$$

where F_{τ}(t), Fₙ(t) are the horizontal and vertical components of the support reaction force.

In various embodiments, the system can also determine muscle elasticity energy and can output the resulting data in the form of tables.

The system can also use, as input, the parameters uₛᵣ (the average horizontal velocity of the runner's CM), m (the runner's mass), h₀ (height of the CM, which can be calculated according to the age, sex, mass and height of the person), and φ (angle of inclination). Note that athletes with strong leg muscles (runners, hockey players, football players) tend to have a lower CM.

The system can maintain the correlation relationships ω(usr) and λ(usr):

$$ω ( {u}_{s r} ) = 0.971 + 0.8 {u}_{s r} - 0.048 {u}_{s r}^{2} ; \qquad ( 25 )$$

$$λ ( {u}_{s r} ) = 0.284 {u}_{s r} - 0.0187 {u}_{s r}^{2} ; \qquad ( 26 )$$

These equations are embedded in the blocks ω(usr) and λ(usr) of FIG. 9. Further, ω and λ will be determined by individual tables for each athlete.

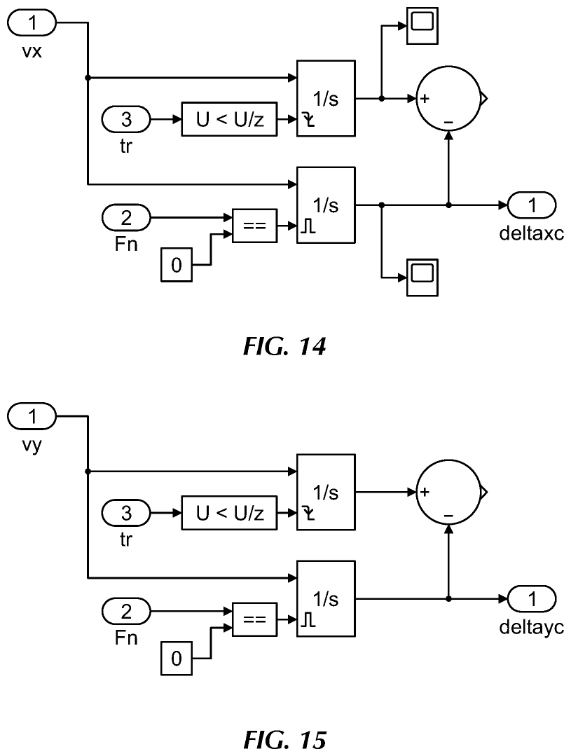

FIG. 14 illustrates a submodel ω(usr) in accordance with disclosed embodiments. FIG. 15 illustrates a submodel λ(usr) in accordance with disclosed embodiments.

Stand-up time as

$${t}_{c} = \frac{λ}{u ,}$$

cannot be easily determined, as the average speed during standing is lower than the average running speed. The variables u_{src} and u_{srf} represent the average speeds during the strut and during the flight respectively. These can be expressed as:

$${u}_{s r c} \cdot {t}_{c} + {u}_{s r f} \cdot {t}_{f} = \frac{{u}_{sr}}{ω} ; \qquad ( 27 )$$

$${u}_{s r c} \cdot {t}_{c} = λ ; \qquad ( 28 )$$

$${t}_{c} + {t}_{f} = \frac{1}{ω} ; \qquad ( 29 )$$

System (27)-(29) has four unknowns, but only three equations. Therefore, in this system the system also uses the rack time t_{c}, as

$${t}_{c} = \frac{λ}{0.991 {u}_{sr}} \qquad ( 30 )$$

Relation (30) can be improved after collecting experimental data. The system can then use:

$${t}_{f} = \frac{1}{ω} - {t}_{c} ; \qquad ( 31 )$$

$${u}_{s r f} = \frac{{u}_{sr} - ω λ}{ω {t}_{f}} ; \qquad ( 32 )$$

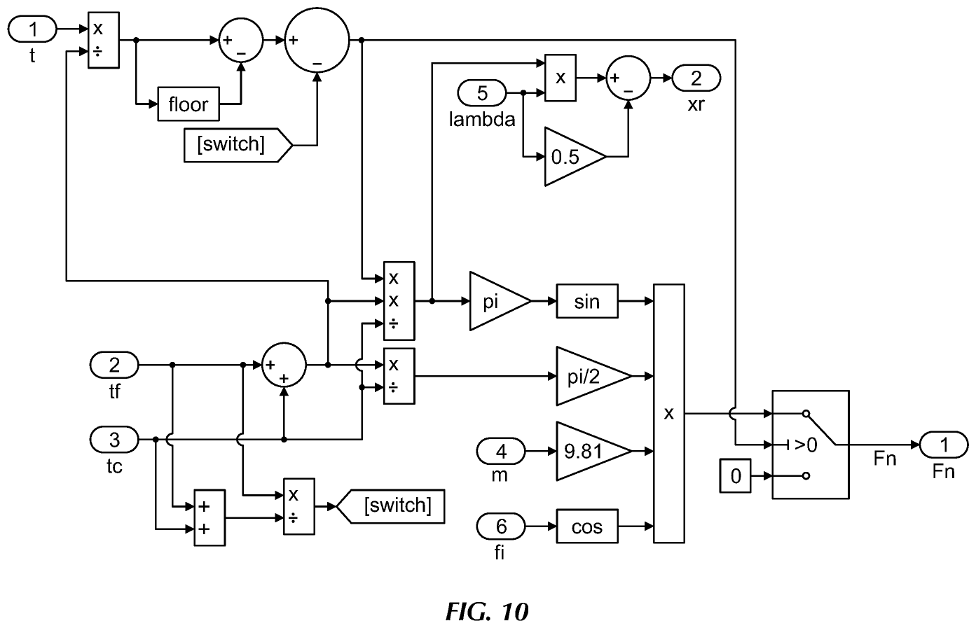

These equations form the basis of the kinematic block. FIG. 10 illustrates a corrected kinematic block generalized for angles, in accordance with disclosed embodiments.

The system uses u₀ as the initial velocity of the flight, and u₁ as the final velocity of the flight in projection on Ox. By analogy, υ₀ is initial velocity of flight, υ₁ is final velocity of flight in projection on Oy. Then,

$${u}_{1} = {u}_{0} - g {t}_{f} sin φ ; \qquad ( 33 )$$

$${v}_{1} = {v}_{0} - g {t}_{f} cos φ ; \qquad ( 34 )$$

Knowing the average horizontal speed during flight, the system can determine u₁ and u₀:

$${u}_{1} = {u}_{s r f} - \frac{g {t}_{f} sin φ}{2} ; \qquad ( 35 )$$

$${u}_{0} = {u}_{s r f} + \frac{g {t}_{f} sin φ}{2} ; \qquad ( 36 )$$

Given that the average velocity in projection to Oy is 0, the system can determine:

$${v}_{0} = \frac{g {t}_{f} cos φ}{2} , \qquad ( 37 )$$

$${v}_{1} = - \frac{g {t}_{f} cos φ}{2} \qquad ( 38 )$$

The system can determine the support reaction force and movement of the CM in the horizontal plane. The horizontal velocity of the CM must increase from u₁ to u₀ during the stall. That is:

$$m {\int }_{{t}_{f}}^{{t}_{f} + {t}_{c}} \ddot{x} dt = {\int }_{{t}_{f}}^{{t}_{f} + {t}_{c}} {F}_{τ} ( t ) d t - {\int }_{{t}_{f}}^{{t}_{f} + {t}_{c}} mg sin φ dt , m ( {u}_{0} - {u}_{1} ) = {\int }_{{t}_{f}}^{{t}_{f} + {t}_{c}} {F}_{τ} ( t ) dt - mg sin φ {t}_{c} , {\int }_{{t}_{f}}^{{t}_{f} + {t}_{c}} {F}_{τ} ( t ) d t = m ( {u}_{0} - {u}_{1} ) + mg sin φ {t}_{c} ; Then : \\ {\int }_{{t}_{f}}^{{t}_{f} + {t}_{c}} {F}_{τ} ( t ) dt = mg sin φ ( {t}_{c} + {t}_{f} ) ; And : \\ {\int }_{{t}_{f}}^{{t}_{f} + {t}_{c}} {F}_{τ} ( t ) d t = \frac{mg sin φ}{ω} ; \qquad ( 39 )$$

That is, the area under the graph F_{τ}(t) must be more than 0 if φ>0.

To determine movement of the CM in the vertical plane:

$$m {\int }_{{t}_{f}}^{{t}_{f} + {t}_{c}} \ddot{y} d t = {\int }_{{t}_{f}}^{{t}_{f} + {t}_{c}} {F}_{n} ( t ) d t - {\int }_{{t}_{f}}^{{t}_{f} + {t}_{c}} mg cos φ dt , {\int }_{{t}_{f}}^{{t}_{f} + {t}_{c}} {F}_{n} ( t ) d t = \frac{mg cos φ}{ω} ; \qquad ( 40 )$$

and:
Consequently, Fₙ(t) will be equal (given the sinusoidal profile):

$${F}_{n} ( t ) = 0 if \{ \frac{t}{{t}_{f} + {t}_{c}} \} ∈ [ 0 , \frac{t}{{t}_{f} + {t}_{c}} ] \\ {F}_{n} ( t ) = \frac{π mg cos φ}{2} \cdot \frac{{t}_{f} + {t}_{c}}{{t}_{c}} \cdot sin ( \frac{{t}_{f} + {t}_{c}}{{t}_{c}} \cdot π ( \{ \frac{t}{{t}_{f} + {t}_{c}} \} - \frac{{t}_{f}}{{t}_{f} + {t}_{c}} ) ) if \{ \frac{t}{{t}_{f} + {t}_{c}} \} ∈ [ \frac{{t}_{f}}{{t}_{f} + {t}_{c}} , 1 ] \qquad ( 41 )$$

FIG. 10 illustrates a block Fₙ(t) Fourier series equation in accordance with disclosed embodiments.

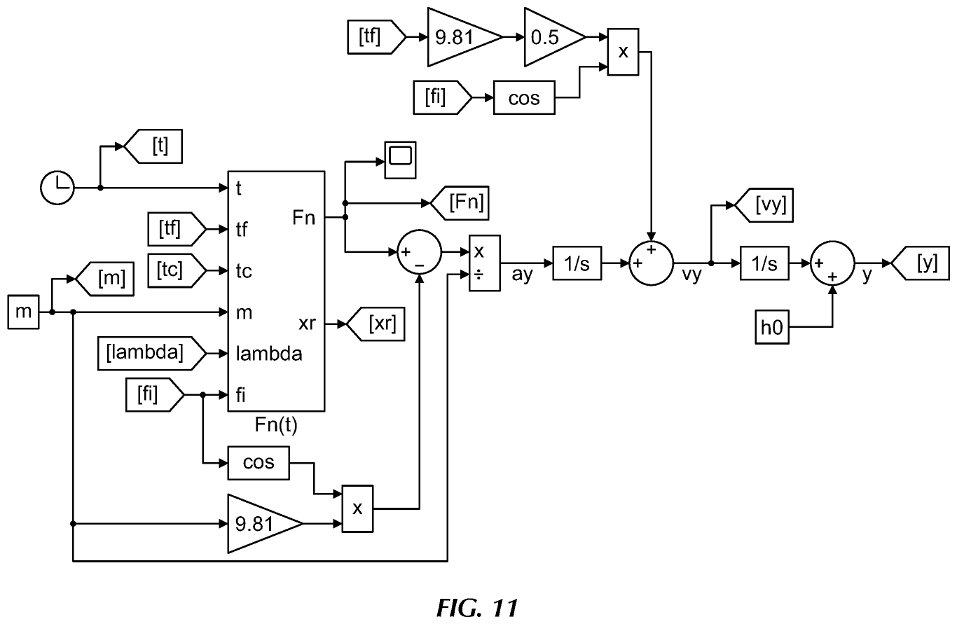

The equation of motion along the Oy axis is a separate submodel. The initial velocity of motion is equal to ν0 and the position of the CM is assumed to be equal to h₀. FIG. 11 illustrates a submodel for the equation of motion along the Oy axis in accordance with disclosed embodiments.

The system can model the horizontal component of the support reaction force and can determine the change in time of F_{τ}(t). On the one hand, the relation

$${F}_{τ} ( t ) = \frac{{x}_{r}}{y} {F}_{n} ( t )$$

is fulfilled since it is assumed that the line of action of the support reaction force passes through the human CM. Here xᵣ is the projection of CM position on the horizontal axis relative to the point on which the equilibrium support reaction force acts.

$${x}_{r} = \frac{{t}_{f} + {t}_{c}}{{t}_{c}} \cdot ( \{ \frac{t}{{t}_{f} + {t}_{c}} \} - \frac{{t}_{f}}{{t}_{f} + {t}_{c}} ) λ - \frac{λ}{2} ; \qquad ( 42 )$$

However if F_{τ}(t) changes this way, its shape is close to a sinusoid, and it is known that for sinusoidal functions ∫₀^{2πf}F_{τ}(t)dt=0, which doesn't suit when the angle is φ≠0. Therefore, the system can use a second component of the horizontal support reaction force, such that:

$${\int }_{{t}_{f}}^{{t}_{f} + {t}_{c}} {F}_{τ 2} ( t ) dt = \frac{mg sin φ}{ω} ;$$

A similar equation is solved for Fₙ(t). Thus:

$${F}_{τ} ( t ) = {F}_{τ 1} ( t ) + {F}_{τ 2} ( t ) , \\ where : \\ {F}_{τ 1} ( t ) = \frac{{x}_{r}}{y} {F}_{n} ( t ) , {F}_{τ 2} ( t ) = tg φ {F}_{n} ( t ) ,$$

Consequently, F_{τ}(t) depends only on Fₙ(t) and the CM position,

$${F}_{τ} ( t ) = ( \frac{{x}_{r}}{y} + tg φ ) {F}_{n} ( t ) ; \qquad ( 43 )$$

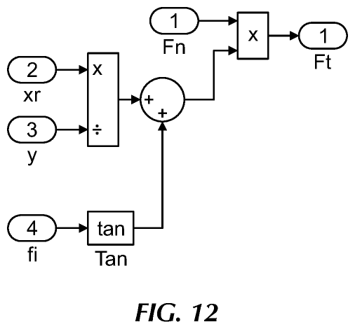

FIG. 12 illustrates block F_{τ}(t) in accordance with disclosed embodiments.

The equation of motion along the Ox-axis is a separate submodel. The initial velocity of motion is equal to u₀. The initial position of the CM is assumed to be 0. FIG. 13 illustrates a submodel for the equation of motion along the Ox-axis in accordance with disclosed embodiments.

The system can determine elasticity energy and the work of the support reaction force. The system can derive a formula describing the work of the support reaction force:

$$m \vec{a} = {\vec{F}}_{τ} ( t ) + {\vec{F}}_{n} ( t ) + m \vec{g} \qquad ( 44 )$$

Let d\vec{l} be an instantaneous displacement of the CM. Multiply both parts of equation (44) by d\vec{l}:

$$m \vec{a} \cdot d \vec{l} = {\vec{F}}_{τ} ( t ) \cdot d \vec{l} + {\vec{F}}_{n} ( t ) \cdot d \vec{l} + m \vec{g} \cdot d \vec{l} m \frac{d \vec{v}}{d t} \cdot d \vec{l} = {F}_{τ} ( t ) \cdot dx + {F}_{n} ( t ) \cdot dy - mg sin φ \cdot dx - mg cos φ \cdot dy mvdv = {F}_{τ} ( t ) \cdot dx + {F}_{n} ( t ) \cdot dy - mg sin φ \cdot dx - mg cos φ \cdot dy \qquad ( 45 )$$

The system can integrate both parts of equation (45) from the moment when the person first lands to the current moment in time:

$${\int }_{v ( {t}_{f} )}^{v ( t )} mvdv = {\int }_{x ( {t}_{f} )}^{x ( t )} {F}_{τ} ( t ) \cdot dx + {\int }_{y ( {t}_{f} )}^{y ( t )} {F}_{n} ( t ) \cdot dy - {\int }_{x ( {t}_{f} )}^{x ( t )} mg sin φ \cdot dx - {\int }_{y ( {t}_{f} )}^{y ( t )} mg cos φ \cdot dy ; \qquad ( 46 )$$

After substituting all values and calculating the integral, we find:

$$\frac{m}{2} ( {v}_{x}^{2} + {v}_{y}^{2} - {v}_{x 1}^{2} + {v}_{y 1}^{2} ) = {A}_{F} - mg sin φ ( x - {x}_{1} ) - mg cos φ ( y - {y}_{1} ) ;$$

where vₓ, v_{y} are current velocity projections on the axis Ox and Oy, vₓ₁, v_{y1} are the velocity projections in the time moment t=t_{f}:

$${v}_{x 1} = {u}_{1} = {u}_{srf} - \frac{{gt}_{f} sin φ}{2} ; \\ {v}_{y 1} = - \frac{{gt}_{f} cos φ}{2} ;$$

x₁, y₁ is CM position at the time moment t=t_{f}.

Thus, the system can use:

$${A}_{F} = Δ {W}_{K} + Δ {W}_{P} , \qquad ( 47 )$$

as the law of conservation of energy for this system.

The components x−x₁ and y−y₁ are calculated like variables Δx_{c} and Δy_{c} in the blocks Δx_{c} and Δy_{c} respectively. FIG. 14 illustrates a submodel for the block Δx_{c} in accordance with disclosed embodiments. FIG. 15 illustrates a submodel for the block Δy_{c} in accordance with disclosed embodiments. The calculation principle is the same:

$${t}_{r} = \{ \frac{t}{{t}_{f} + {t}_{c}} \} ,$$

changes from 0 to 1.

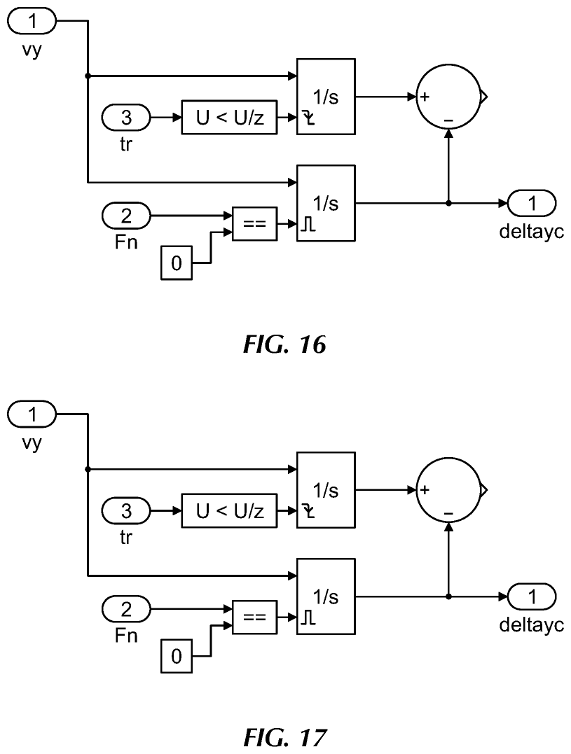

As soon as tᵣ decreases from 1 to 0 (a new period begins), the value of the upper integral is reset to 0 and the integration starts again. The value of the lower integral depends on whether Fn(t)=0. If yes, that is, when the person is in the air, its value is 0; if no, the integral is calculated. The difference of these 2 values is equal to the movement of the person's CM during the time he touches the ground. FIG. 16 illustrates a submodel for determining the change in potential energy ΔW_{P} in accordance with disclosed embodiments.

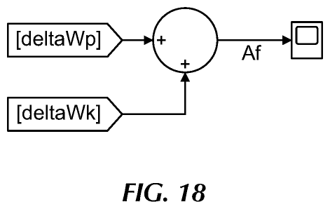

FIG. 17 illustrates a submodel for the calculation of the change in kinetic energy ΔW_{K}. FIG. 18 illustrates a submodel for the calculation of the work of the support reaction force.

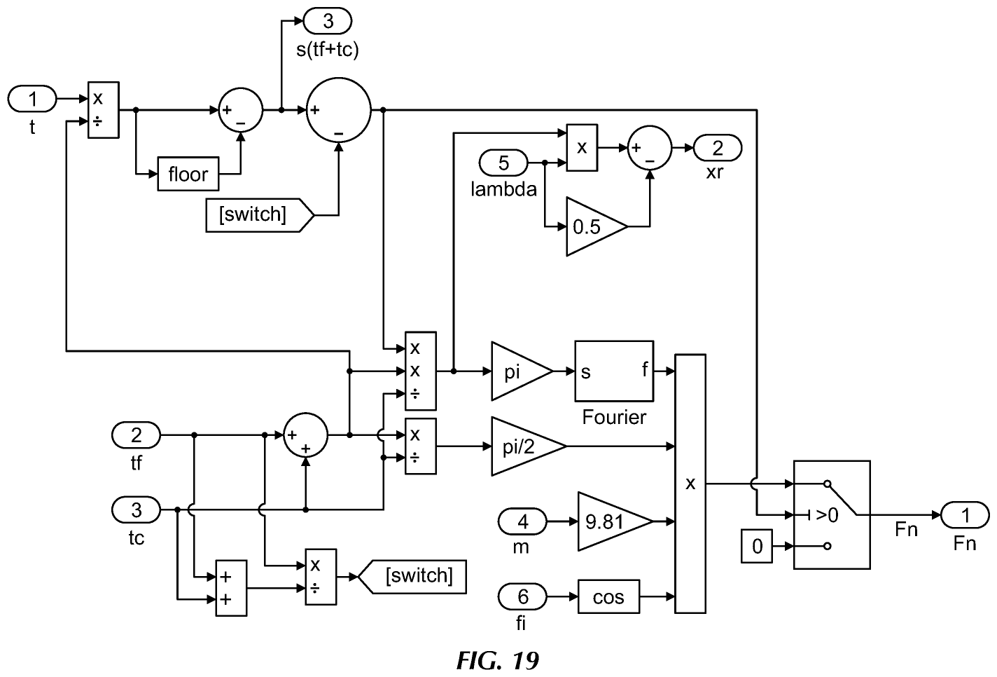

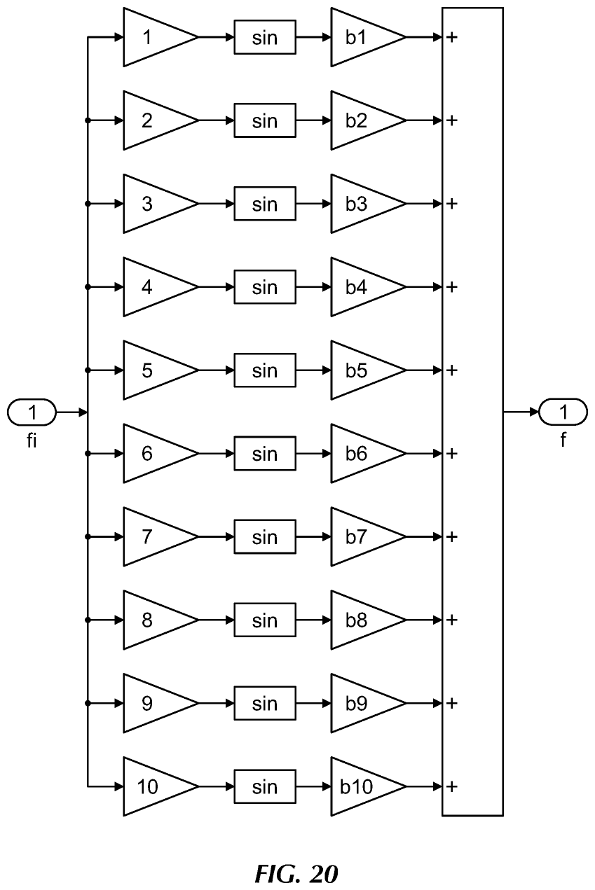

FIGS. 19 and 20 illustrate the Fourier model added to the calculation of the support reaction force, in accordance with disclosed embodiments.

The system can calculate the coefficients b1-b10 and then corrected for:

$${b}_{n} = \frac{1}{π} {\int }_{- π}^{π} f ( x ) sin nx dx \qquad ( 49 )$$

In this case, to fulfill the conditions that the function y(t) and y(t) must be periodic via the integration of the power dependence (26) once and twice, respectively, we obtain that the coefficients must be corrected:

$${\sum }_{n} {b}_{n} = 2 , {\sum }_{k} {b}_{2 k} = 0 , \qquad ( 50 )$$

With the 2-hump characteristic, the calculations became more accurate.

Various embodiments can use techniques, processes, and features as described in the documents cited below, all of which are hereby incorporated by reference:
David F. Jenny and Patrick Jenny, “On the mechanical power output required for human running—Insight from an analytical model” (Journal of Biomechanics, Volume 110, 2020).
Lacirignola et al., “Biomechanical Sensing and Algorithms” (Lincoln Laboratory Journal, Vol. 24, No. 1, 2020).
Myer et al., “Biomechanics laboratory-based prediction algorithm to identify female athletes with high knee loads that increase risk of ACL injury,” (Br. J. Sports Med., 45(4), 245-252, 2010).
Kidzinski et al., “Deep neural networks enable quantitative movement analysis using single-camera videos” (Nature Communications, 2020).
Jamakiram, “Demystifying Edge Computing-Device Edge vs. Cloud Edge” (Forbes, Sep. 15, 2017).
Delattre et al., “Dynamic similarity during human running: About Froude and Strouhal dimensionless numbers” (Journal of Biomechanics, Volume 42, 2009).
Blickhan, “The Spring-Mass Model for Running and Hopping” (Journal of Biomechanics, Volume 22, 1989).
McMahon and Cheng, “The Mechanics of Running: How Does Stiffness Couple with Speed” (Journal of Biomechanics, Volume 23, Supp. 1, 1990).
U.S. Pat. No. 10,705,566B2.
U.S. Pat. No. 9,452,341B2.

Of course, those of skill in the art will recognize that, unless specifically indicated or required by the sequence of operations, certain steps in the processes described above may be omitted, performed concurrently or sequentially, or performed in a different order. The various steps, processes, and features described above can be combined in any way within the scope of this disclosure.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the various systems disclosed may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle. The use of terms such as (but not limited to) “mechanism,” “module,” “device,” “unit,” “component,” “element,” “member,” “apparatus,” “machine,” “system,” “processor,” or “controller,” within a claim is understood and intended to refer to structures known to those skilled in the relevant art, as further modified or enhanced by the features of the claims themselves, and is not intended to invoke 35 U.S.C. § 112(f).

What is claimed is:

1.-19. (canceled)

20. A method performed within a mobile device, the method comprising:
capturing video of a human runner to obtain one or more parameters including at least one of: a speed u, a contact time tc, and a flight time tf; and
operating on the one or more parameters with a biomechanics model implemented by the mobile device to produce one or more running metrics including at least one of: a total power P as a function of time t, an average power Psr, and a specific average power Psr/mu.

21. The method of claim 20, wherein said capturing video is performed by a camera system of the mobile device.

22. The method of claim 20, further comprising refining the one or more running metrics based on subsequent frames of the video.

23. The method of claim 20, wherein said operating on the one or more parameters includes:
determining a vertical power Pvert as a function of time t;
determining a horizontal power Ptr as a function of time t; and
calculating the total power P based at least in part on the vertical power Pvert and the horizontal power Ptr.

24. The method of claim 23, wherein said determining the vertical power Pvert includes:
deriving a normal force Fn as a function of time t for the human runner based on the one or more parameters obtained from capturing the video;
converting the normal force Fn into a vertical acceleration component ay of a center of mass, a vertical velocity component vy of the center of mass, and a vertical position component y of the center of mass;
determining the vertical power Pvert as a function of time t based on the normal force Fn and the vertical velocity component vy.

25. The method of claim 24, wherein said determining the horizontal power Ptr includes:
deriving a horizontal projection xr of the center of mass as a function of time t;
combining the normal force Fn, horizontal projection xr, and vertical position component y, to obtain a horizontal force Fτ;
determining the horizontal power Ptr as a function of time t based on the horizontal force Fτ and a runner speed u.

26. The method of claim 23, wherein said operating on the one or more parameters includes:
determining an aerodynamic drag power Pa,
wherein said calculating the total power P is also based on the aerodynamic drag power Pa.

27. A mobile device comprising a camera system, a processor, and a run-analysis application configuring the processor to:
use the camera system to capture video of a human runner;
process the video to obtain one or more parameters including at least one of: a speed u, a contact time tc, and a flight time tf; and
operate on the one or more parameters with a biomechanics model to produce one or more running metrics including at least one of: a total power P as a function of time t, an average power Psr, and a specific average power Psr/mu.

28. The mobile device of claim 27, wherein the run-analysis application further configures the processor to refine the one or more running metrics based on subsequent frames of the video.

29. The mobile device of claim 27, wherein as part of operating on the one or more parameters, the run-analysis application configures the processor to:
determine a vertical power Pvert as a function of time t;
determine a horizontal power Ptr as a function of time t;
determine an aerodynamic drag power Pa as a function of time t; and
calculate the total power P based at least in part on the vertical power Pvert, the horizontal power Ptr, and the aerodynamic drag power Pa.

30. The method of claim 29, wherein as part of determining the vertical power, the run-analysis application configures the processor to:
derive a normal force Fn as a function of time t for the human runner based on said one or more parameters;
convert the normal force Fn into a vertical acceleration component ay of a center of mass, a vertical velocity component vy of the center of mass, and a vertical position component y of the center of mass; and
determine the vertical power Pvert as a function of time t based on the normal force Fn and the vertical velocity component vy.

31. The method of claim 30, wherein as part of determining the horizontal power Ptr, the run-analysis application configures the processor to:
derive a horizontal projection xr of the center of mass as a function of time t;
combine the normal force Fn, horizontal projection xr, and vertical position component y, to obtain a horizontal force Fτ;
determine the horizontal power Ptr as a function of time t based on the horizontal force Fτ and a runner speed u.

32. A system comprising:
an end-user display; and
an edge device having a camera system, a processor, and a run-analysis application stored in memory, the run-analysis application configuring the edge device to:
use the camera system to capture video of a human runner;
process the video to obtain one or more parameters including at least one of: a speed u, a contact time tc, and a flight time tf;
operate on the one or more parameters with a biomechanics model to produce one or more running metrics including at least one of: a total power P as a function of time t, an average power Psr, and a specific average power Psr/mu; and
to transfer the one or running metrics to the end-user display.

33. The system of claim 32, wherein the run-analysis application further configures the edge device to accept biometric data input from the user, the biometric data input including a mass of the human runner, and wherein the run-analysis application configures the edge device to produce the one or more running metrics based in part on the biometric data input.
